(19) United States
(12) Patent Application Publication
(10) Pub. No.: US 2010/0282210 A1
(43) Pub. Date: Nov. 11, 2010

(54) ELECTRIC THROTTLE CONTROL APPARATUS FOR A MOTORCYCLE

(75) Inventor: Katsuhiko Itagaki, Hamamatsu-Shi (JP)

Correspondence Address: BARNES & THORNBURG LLP, 750-17TH STREET NW, SUITE 900, WASHINGTON, DC, 20006-4675, US

(73) Assignee: SUZUKI MOTOR CORPORATION, Hamamatsu-Shi (JP)

(21) Appl. No.: 12/775,146

(22) Filed: May 6, 2010

(30) Foreign Application Priority Data
May 8, 2009 (JP) 2009-113548

(51) Int. Cl. F02D 11/10; F02D 43/00

(52) U.S. Cl. 123/399; 701/102

(57) ABSTRACT

There are provided an accelerator position sensor, an engine speed sensor, an electric motor, and a control unit. The accelerator position sensor detects an amount of operation of an accelerator grip. The engine speed sensor detects an engine rotational speed. The electric motor rotates a throttle valve so as to be opened and closed an intake passage. The throttle valve is opened and closed by the electric motor. The control unit drives the electric motor depending upon an output value of the accelerator position sensor and the engine speed sensor. The control unit includes a map storage section storing a plurality of throttle valve opening maps. Each of the plurality of throttle valve opening maps contains unique throttle valve opening characteristics respectively. The control unit drives the electric motor based on one of selected the throttle valve opening maps.

### CROSS-REFERENCE TO RELATED APPLICATION

This application is based upon and claims the benefit of priority from Japanese Patent Application No. 2009-113548, filed May 8, 2009; the entire contents of which are incorporated herein by reference.

### BACKGROUND OF THE INVENTION

1. Field of the Invention

The present invention relates to an electric throttle control apparatus for a motorcycle including an electric throttle system and capable of switching among a plurality of driving modes.

2. Description of the Related Art

An intake system including a main throttle valve that is opened and closed when a rider rotates an accelerator grip and a sub-throttle valve that is opened and closed corresponding to an opening of the main throttle valve has been known in the art. An intake system of this type is also called a dual throttle system.

In a throttle valve control apparatus of related art, a dual throttle valve system has a plurality of sub-throttle valve opening maps containing sub-throttle valve opening characteristics different from one another, and the sub-throttle valve is opened and closed based on a selected one of the sub-throttle valve opening maps. The throttle valve control apparatus of the related art can therefore handle a plurality of driving modes and switch to a desired one suitable not only for the situation of the road surface on which a motorcycle travels but also for a rider's driving situation (see Patent Document 1 (Japanese Patent Laid-Open No. 2008-128023), for example).

In a dual throttle system, an electric motor is used to drive the sub-throttle valve, which is provided separately from and independently of the main throttle valve, to control the substantial amount of intake air and hence control the output of the engine.

For example, the dual throttle system is controlled in such a way that a sufficient intake flow rate is ensured in a low engine rotational speed range by reducing the opening of the sub-throttle valve to be smaller than that of the main throttle valve. On the other hand, the dual throttle system is controlled in such a way that a sufficient amount of intake air is ensured in a high engine rotational speed range by increasing the opening of the sub-throttle valve to be larger than that of the main throttle valve.

In view of the above fact, when using a driving mode switching system capable of selecting one from a plurality of driving modes, the dual throttle system is configured in such a way that a plurality of characteristics under which the electric motor that drives the sub-throttle valve is controlled, that is, a plurality of sub-throttle valve opening characteristics are prepared in advance and any one of the sub-throttle valve opening characteristics can be selected.

In general, fuel injection quantity and ignition timing, which are important parameters in engine output control, are both determined by using a three-dimensional map having parameters of the throttle valve opening and the engine rotational speed (see Patent Document 1, for example).

In a dual throttle system, the throttle valve opening is determined in relation to the main throttle valve opening and the sub-throttle valve opening. Specifically, in a low engine rotational speed range, when the rider abruptly rotates the accelerator grip or operates other components to abruptly open the main throttle valve, the sub-throttle valve opening is reduced in size to ensure a sufficient intake flow rate. The substantial amount of intake air thus greatly depends on the sub-throttle valve opening.

In the driving mode switching system used in the dual throttle system described above, since the sub-throttle valve opening characteristics are changed when the driving mode is switched, the fuel injection quantity and the ignition timing determined from the main throttle valve opening and the engine rotational speed are not suitable for the actual amount of intake air.

It is therefore necessary in the driving mode switching system used in the dual throttle system to correct the fuel injection quantity and the ignition timing based on the relationship between the main throttle valve opening and the sub-throttle valve opening whenever the driving mode is switched. The correction performed whenever the driving mode is switched requires a considerable length of time for control processes, whereas improving response characteristics makes it difficult to perform precise control.

To address the problems described above, in the driving mode switching system described in Patent Document 1, instead of correcting the fuel injection quantity and the ignition timing whenever the driving mode is switched, a plurality of fuel injection quantity characteristics and ignition timing characteristics suitable for respective driving modes, in other words, in consideration of sub-throttle valve opening characteristics for respective driving modes, are prepared in advance. The sub-throttle valve opening characteristics, the fuel injection quantity characteristics, and the ignition timing characteristics can all be switched in accordance with the selected one of the driving modes to a combination of the three types of characteristics suitable for the driving mode.

As described above, in the throttle valve control apparatus including the driving mode switching system of the related art, it is necessary to not only simultaneously switch the sub-throttle valve opening characteristics, the fuel injection quantity characteristics, and the ignition timing characteristics to other ones when the driving mode is switched but also prepare a plurality of sub-throttle valve opening characteristics, fuel injection quantity characteristics, and ignition timing characteristics suitable for the types of driving mode. In this case, preparing the variety of characteristics requires a tremendous number of man-hours and a tremendous amount labor and cost. Further, when the total number of driving modes increases, the total number of sub-throttle valve opening characteristics, fuel injection quantity characteristics, and ignition timing characteristics to be prepared increases, disadvantageously resulting in an increased storage capacity necessary in a storage section and hence no storage capacity for storing other functions.

On the other hand, since a dual throttle system includes a main throttle valve and a sub-throttle valve in a throttle body, the length of an intake passage in an engine intake system increases, disadvantageously resulting in significant degradation in intake response characteristics.

To address the problems described above, an electronic throttle system that electronically opens and closes a throttle valve has been developed. The electronic throttle system omits a mechanical main throttle valve that operates when the rider rotates the accelerator grip but instead includes an accelerator position sensor that detects the amount of rotary motion of the accelerator grip operated by the rider and an electric motor driven corresponding to the amount detected by the accelerator position sensor. To make the following description easier, a throttle valve that is opened and closed in an electronic throttle system is called an electronic throttle valve.

### SUMMARY OF THE INVENTION

In view of the circumstances described above, an object of the present invention is to provide an electric throttle control apparatus for a motorcycle having a plurality of driving modes in an electronic throttle system and capable of selecting a desired one of the driving modes and switching the driving mode thereto.

To solve the problems described above, the present invention provides an electric throttle control apparatus for a motorcycle includes an accelerator position sensor, an engine speed sensor, an electric motor, and a control unit. The accelerator position sensor detects an amount of operation of an accelerator grip. The engine speed sensor detects an engine rotational speed. The electric motor rotates a throttle valve so as to be opened and closed an intake passage. The throttle valve is opened and closed by the electric motor. The control unit drives the electric motor depending upon an output value of the accelerator position sensor and the engine speed sensor. The control unit includes a map storage section storing a plurality of throttle valve opening maps. Each of the plurality of throttle valve opening maps contains unique throttle valve opening characteristics respectively. The control unit drives the electric motor based on one of selected the throttle valve opening maps.

In preferred embodiments of the above aspect, the following modes may be provided.

It may be desired that the control unit determines fuel injection quantity based on an opening of the throttle valve and the engine rotational speed.

It may be desired that the control unit determines ignition timing based on an opening of the throttle valve and the engine rotational speed.

It may be desired that the throttle valve opening maps are formed of at least three throttle valve opening maps containing the throttle valve opening characteristics different from one another.

It may be desired that one of the throttle valve opening maps contains reference characteristics. Another one of the throttle valve opening maps contains high-output characteristics in which an opening of the throttle valve used when the amount of operation of the accelerator grip is small is set to be larger than that in the reference characteristics. Another one of the throttle valve opening maps contains low-output characteristics in which a maximum opening of the throttle valve is limited to be lower than or equal to a predetermined opening that is lower than a maximum opening in the reference characteristics.

It may be further desired that a map selector disposed in the vicinity of the accelerator grip. The map selector instructs the control unit to select one of the throttle valve opening maps from the map storage section.

The present invention proposes the electric throttle control apparatus for the motorcycle having a plurality of driving modes in the electronic throttle system and capable of selecting a desired one of the driving modes and switching the driving mode thereto.

The characteristics, operations and advantages of the present invention described above will be more apparently understood by the following description made to the preferred embodiment with reference to the accompanying drawings.

### BRIEF DESCRIPTION OF THE DRAWINGS

FIG. 1 is a left side view showing a motorcycle including an electric throttle control apparatus for a motorcycle according to an embodiment of the present invention;

FIG. 2 is a plan view showing the motorcycle including the electric throttle control apparatus for the motorcycle according to the embodiment of the present invention;

FIG. 3 is a schematic view showing the electric throttle control apparatus for the motorcycle according to the embodiment of the present invention and an engine;

FIG. 4 shows a throttle valve opening map stored in a storage section in the electric throttle control apparatus for the motorcycle according to the embodiment of the present invention;

FIG. 5 shows another throttle valve opening map stored in the storage section in the electric throttle control apparatus for the motorcycle according to the embodiment of the present invention;

FIG. 6 shows another throttle valve opening map stored in the storage section in the electric throttle control apparatus for the motorcycle according to the embodiment of the present invention;

FIG. 7 shows another throttle valve opening map stored in the storage section in the electric throttle control apparatus for the motorcycle according to the embodiment of the present invention;

FIG. 8 shows another throttle valve opening map stored in the storage section in the electric throttle control apparatus for the motorcycle according to the embodiment of the present invention;

FIG. 9 shows another throttle valve opening map stored in the storage section in the electric throttle control apparatus for the motorcycle according to the embodiment of the present invention; and

FIG. 10 is a flowchart showing driving mode switching control performed by the electric throttle control apparatus for the motorcycle according to the embodiment of the present invention.

### DETAILED DESCRIPTION OF THE PREFERRED EMBODIMENT

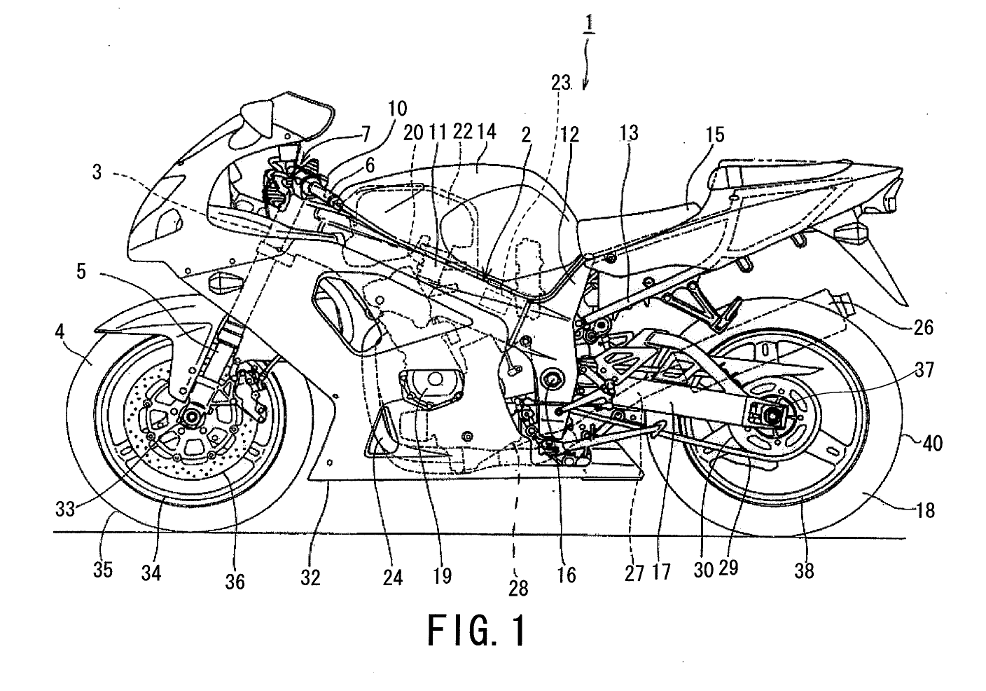

An embodiment of an electric throttle apparatus for a motorcycle according to the present invention will be described below with reference to FIGS. 1 to 10. It will be understood that the words describing directions, such as “upper”, “lower”, “left” and “right”, or like terms, are used herein with reference to illustrated states in the drawings or in actually usable state of the electric throttle apparatus.

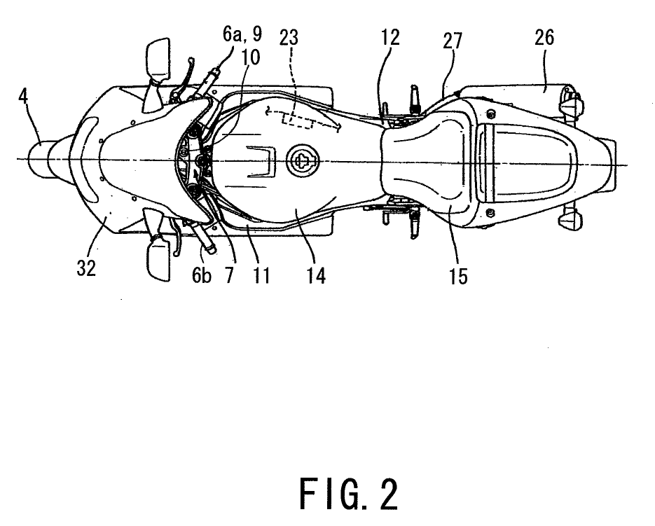

FIG. 1 is a left side view showing a motorcycle including the electric throttle control apparatus for the motorcycle according to the embodiment of the present invention. FIG. 2 is a plan view showing the motorcycle including the electric throttle control apparatus according to the embodiment of the present invention.

As shown in FIGS. 1 and 2, the motorcycle 1 includes a vehicle body frame 2 and a head pipe 3 provided in front thereof. A steering shaft (not shown) is incorporated in the head pipe 3, and a steering mechanism 7 is provided. The steering mechanism 7 is formed of a pair of right and left front forks 5 that rotatably support a front wheel section 4, a handle bar 6, the steering shaft, and other components. The front wheel section 4 is rotatably steered by the handle bar 6 to the right and left. Handle grips 6a and 6b are provided on the right and left sides of the handle bar 6. The right handle grip 6a is an accelerator grip 9 and rotatable over a predetermined angular range, for example, from 0 to 110 degrees. An ignition switch 10 is provided in the vicinity of the handle bar 6.

The vehicle body frame 2 has, for example, a twin-tube shape and includes a pair of right and left main frames 11 that extend away from each other rightward and leftward immediately behind the head pipe 3, each of the main frames also serving as a tank rail extending diagonally downward and rearward in parallel to each other. The vehicle body frame 2 further includes a pair of right and left center frames 12 integrally connected to rear end portions of the main frames 11 and extending substantially upward and downward and a pair of right and left seat rails 13 extending from the upper rear ends of the center frames 12 diagonally upward and rearward.

A fuel tank 14 is disposed above the main frames 11. A driving seat 15 is disposed above the seat rails 13. A pivot shaft 16 is installed in a substantially central lower portion of the center frames 12. A swing arm 17 is assembled to the pivot shaft 16 so that the swing arm 17 swings around the pivot shaft 16. A rear wheel section 18 is rotatably supported by the rear ends of the swing arm 17.

A four-stroke, multi-cylinder engine 19 or any other suitable engine is placed in a central lower portion of the motorcycle 1, that is, in the vehicle body frame 2 below the fuel tank 14.

A throttle body 20 that forms an engine intake system is connected to an upper rear portion of the engine 19. An air cleaner 22 is connected to an upstream portion of the throttle body 20. The engine intake system includes an electric throttle control apparatus 23.

On the other hand, an exhaust pipe 24 that forms an engine exhaust system is connected to a front portion of the engine 19. The exhaust pipe 24 extends rearward around a lower portion of the engine 19, and a muffler 26 extending diagonally upward and rearward is disposed on one side of the vehicle body, specifically, on the right side of the rear wheel section 18 in the present embodiment. The exhaust pipe 24 is connected to the muffler 26 with a connection pipe 27.

The output from the engine 19 is transmitted by a chain 29, which forms a secondary reduction mechanism 28, to the rear wheel section 18 via a driven sprocket 30.

At least part of the vehicle body of the motorcycle 1, specifically, the portion from a front portion to a central lower portion of the vehicle body in the present embodiment, is covered with a streamline cowling 32, which is intended to reduce air resistance produced when the motorcycle 1 travels and protect the rider from travel wind pressure.

The front wheel section 4 includes a front wheel 34 supported by the front forks 5 so that the front wheel 34 can rotate around a front wheel axle 33, a front wheel tire 35 attached to the outer circumferential portion of the front wheel 34, and a front wheel brake plate 36 fixed to the front wheel 34 with bolts or any other suitable fasteners.

The rear wheel section 18 includes a rear wheel 38 supported by the swing arm 17 so that the rear wheel 38 can rotate around a rear wheel axle 37, a rear wheel tire 40 attached to the outer circumferential portion of the rear wheel 38, and a rear wheel brake plate (not shown) fixed to the rear wheel 38 with bolts or any other suitable fasteners.

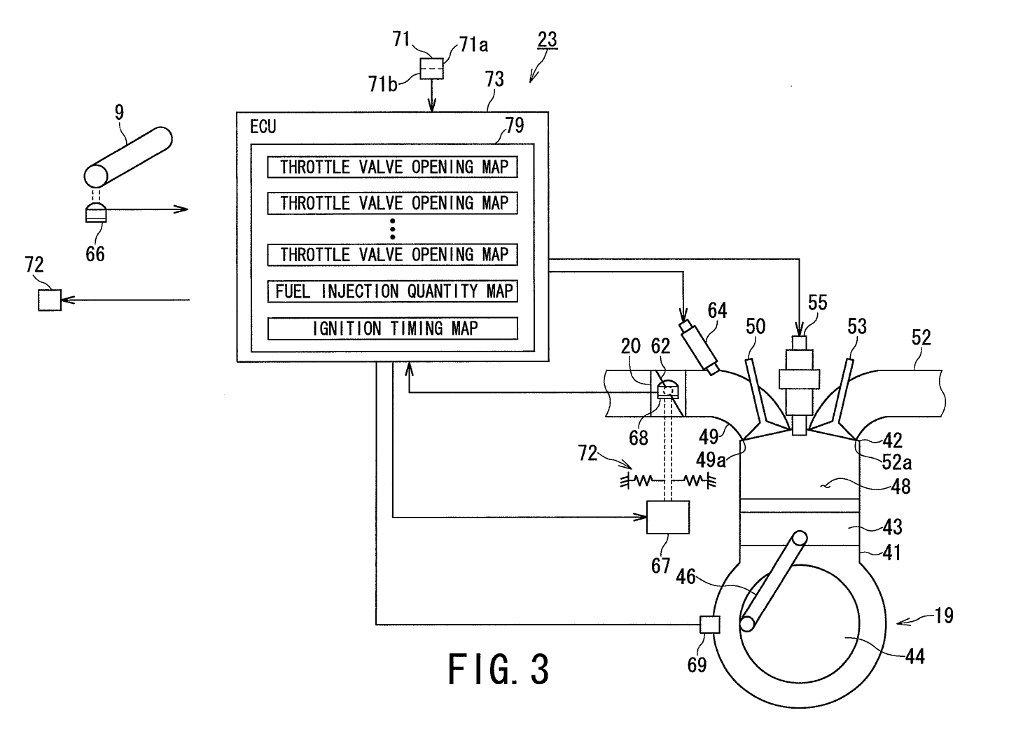

FIG. 3 is a schematic view showing the electric throttle control apparatus for the motorcycle according to the embodiment of the present invention and the engine.

As shown in FIG. 3, the engine 19 includes a cylinder block 41, a cylinder head 42, a piston 43, a crankshaft 44, a connecting rod 46, a combustion chamber 48, an intake pipe 49, an intake valve 50, an exhaust pipe 52, an exhaust valve 53, and an ignition plug 55.

The cylinder head 42 is fixed to the cylinder block 41.

The piston 43 is accommodated in the cylinder block 41 in such a way that the piston 43 can make reciprocating motion.

The crankshaft 44 is rotatably accommodated in the cylinder block 41.

The connecting rod 46 has one end swingably connected to the crankshaft 44 and the other end swingably connected to the piston 43. The connecting rod 46 converts the reciprocating motion of the piston 43 into rotary motion of the crankshaft 44.

The combustion chamber 48 is formed of a partitioned space surrounded by the piston 43, the cylinder block 41, and the cylinder head 42.

The intake pipe 49 and the exhaust pipe 52 communicate with the combustion chamber 48.

The intake valve 50 is provided on the cylinder head 42 and opens and closes an intake port 49a of the intake pipe 49.

The exhaust valve 53 is provided on the cylinder head 42 and opens and closes an exhaust port 52a of the exhaust pipe 52.

The ignition plug 55 is disposed in the combustion chamber 48.

The throttle body 20 is provided in the intake pipe 49. A throttle valve 62 as the electronic throttle valve is provided in the throttle body 20. The throttle valve 62 is opened and closed by the electric throttle control apparatus 23 corresponding to the opening of the accelerator grip 9 attached to the handle bar 6.

An injector 64 as a fuel injection device is provided between the throttle valve 62 and the intake valve 50. The injector 64 is connected to a strainer (not shown), a fuel pump (not shown), and a pressure control valve (pressure regulator, not shown) disposed in the fuel tank 14. It is noted that the engine 19 has, for example, an independent intake system and the injector 64 is provided for each of the cylinders.

The electric throttle control apparatus 23 opens and closes the throttle valve 62 corresponding to the amount of operation of the accelerator grip 9 (accelerator opening). The electric throttle control apparatus 23 includes the accelerator grip 9, an accelerator position sensor 66, an electric motor 67, the throttle valve 62, a throttle position sensor 68, an engine speed sensor 69, a driving mode switch 71, a driving mode display 72, and an electric control unit 73.

The accelerator position sensor 66 detects the accelerator opening of the accelerator grip 9 and outputs the detected value to the electric control unit 73.

The electric motor 67 is driven by the electric control unit 73 corresponding to the accelerator opening of the accelerator grip 9 detected by the accelerator position sensor 66. The electric motor 67 rotates the throttle valve 62 so as to be opened and closed an intake passage

The throttle valve 62 is opened and closed by the electric motor 67.

The throttle position sensor 68 detects the throttle opening (actual opening) of the throttle valve 62 and outputs the detected value to the electric control unit 73.

The engine speed sensor 69 detects the engine rotational speed of the engine 19 based on the crankshaft 44 rotation frequency and outputs the detected value to the electric control unit 73.

The driving mode switch 71, when operated by the rider, sends a driving mode switching signal to the electric control unit 73. The driving mode switch 71 is provided in the vicinity of the right handle grip 6a or the left handle grip 6b, on the fuel tank 14, on a meter (not shown) provided in the vicinity of the handle bar 6, or in any other place readily accessible to the rider during driving. The driving mode switch 71 includes a forward switch 71a and a backward switch 71b. When operated by the rider, the forward switch 71a sends a forward signal to the electric control unit 73. On the other hand, the backward switch 71b, when operated by the rider, sends a backward signal to the electric control unit 73. The forward and backward signals are driving mode switching signals.

The driving mode display 72 displays the driving mode selected by using the driving mode switch 71.

The electric control unit 73 controls the operation of the engine 19. The electric control unit 73 is formed, for example, of a microcomputer (not shown) and includes a storage section 79 formed of a semiconductor memory or any other suitable storage device.

The storage section 79 stores a fuel injection quantity map containing fuel injection quantity characteristics, an ignition timing map containing ignition timing characteristics, and a plurality of throttle valve opening maps containing throttle valve opening characteristics different from one another. Each of the throttle valve opening maps is what is called a three-dimensional map formed of the accelerator opening of the accelerator grip 9, the engine rotational speed of the engine 19, and a target opening of the throttle valve 62. On the other hand, the fuel injection quantity map and the ignition timing map are three-dimensional maps formed of the throttle opening of the throttle valve 62 detected by the throttle position sensor 68, the engine rotational speed of the engine 19, and the corresponding one of the fuel injection quantity and the ignition timing. The storage section 79 can store the driving mode selected by using the driving mode switch 71 when the motorcycle 1 traveled last time. The driving mode to be used when the motorcycle 1 travels for the first time can be arbitrarily selected in advance.

The electric control unit 73 drives the electric motor 67 depending upon an output values of the accelerator position sensor 66, the throttle position sensor 68, and the engine speed sensor 69 to control the operation of the engine 19.

Specifically, the electric control unit 73 receives detection results or signals as control inputs thereto from the accelerator position sensor 66, the throttle position sensor 68, the engine speed sensor 69, and the driving mode switch 71. The electric control unit 73 can also receive a detection result from a pressure sensor (not shown) that detects the pressure in the intake pipe 49.

On the other hand, the electric control unit 73 outputs control signals based on the control inputs to the injector 64, the ignition plug 55, and the electric motor 67. The electric control unit 73 controls the fuel injection quantity by using the fuel pump and the injector 64, the ignition timing by using the ignition plug 55, and the opening of the throttle valve 62 by using the electric motor 67 so that the operation of the engine 19 is controlled.

The electric control unit 73 drives the electric motor 67 based on one of the selected throttle valve opening maps. The electric control unit 73 selects one of the throttle valve opening maps from the storage section 79 based on the driving mode switching signal inputted from the driving mode switch 71 and displays the selected driving mode on the driving mode display 72 so that the operation of the engine 19 is controlled.

More specifically, the electric control unit 73 searches throttle valve opening maps based on the accelerator opening detected by the accelerator position sensor 66 and the engine rotational speed detected by the engine speed sensor 69, determines a target opening of the throttle valve 62, and performs feed-forward control (hereinafter simply referred to as FF control) of the engine 19. The target opening of the throttle valve 62 is a throttle opening to be achieved by the throttle valve 62 corresponding to the accelerator opening detected by the accelerator position sensor 66 and the engine rotational speed detected by the engine speed sensor 69, and determined by using the selected one of the throttle valve opening maps. The electric control unit 73 determines a target duty value of the electric motor 67 that allows the target opening of the throttle valve 62 to be maintained.

The electric control unit 73 further performs feedback control (hereinafter simply referred to as FB control) by which the throttle opening of the throttle valve 62 is forced to approach the target opening in accordance with the deviation between the target opening (target value) of the throttle valve 62 calculated in the FF control and the throttle opening (actual opening) of the throttle valve 62 detected by the throttle position sensor 68.

Further, the electric control unit 73 searches the fuel injection quantity map and the ignition timing map based on the throttle opening of the throttle valve 62 detected by the throttle position sensor 68 and the engine rotational speed detected by the engine speed sensor 69, and determines the quantity of fuel injected by the fuel pump and the injector 64 and the ignition timing of the ignition plug 55 to control the operation of the engine 19.

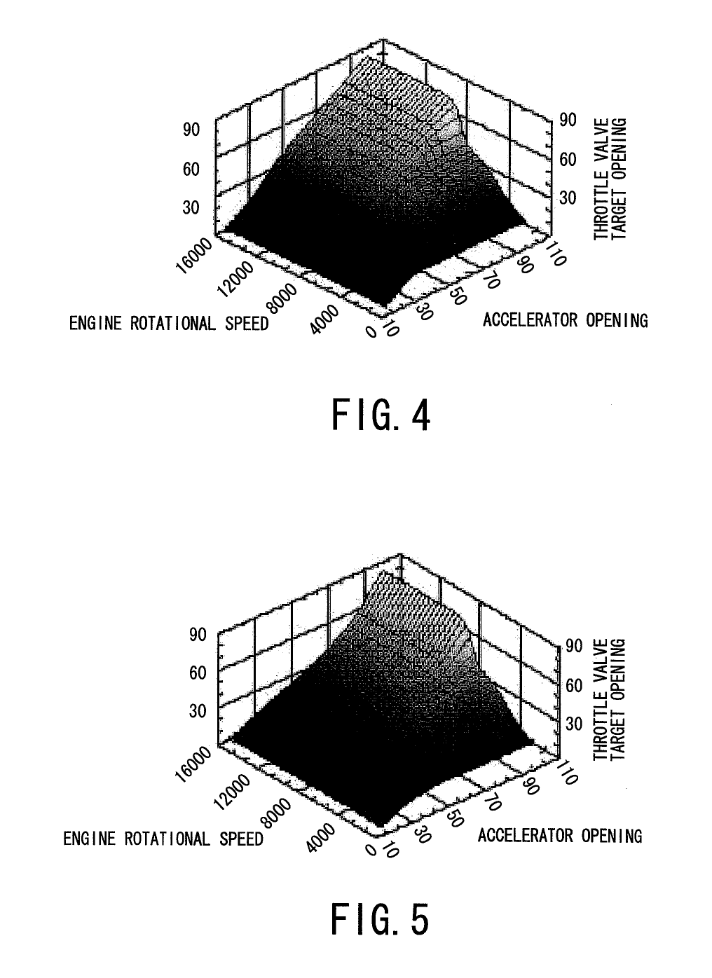

FIGS. 4 to 9 show the throttle valve opening maps stored in the storage section in the electric throttle control apparatus for the motorcycle according to the embodiment of the present invention.

As shown in FIGS. 4 to 9, the storage section 79 in the electric control unit 73 stores a plurality of throttle valve opening maps. Each of the plurality of throttle valve opening maps contains unique throttle valve opening characteristics respectively. Each of the plurality of throttle valve opening maps is set in advance in correspondence with a single driving mode selectable by operating the driving mode switch 71 and stored in the storage section 79. The target opening of the throttle valve 62 is determined from the accelerator opening of the accelerator grip 9 and the engine rotational speed of the engine 19 by using one of the throttle valve opening maps.

In particular, the throttle valve opening maps shown in FIGS. 4 to 6 correspond to three types of driving mode: among selectable driving modes, a high-output mode, a low-output mode, and an intermediate-output mode set in between the high-output mode and the low-output mode and having intermediate output characteristics.

FIG. 4 shows the throttle valve opening map corresponding to the high-output mode. This throttle valve opening map is set in such a way that the target opening of the throttle valve 62 progressively increases as the accelerator opening increases.

FIG. 5 shows the throttle valve opening map corresponding to the intermediate-output mode. This throttle valve opening map is set in such a way that the rate at which the target opening of the throttle valve 62 increases in a low accelerator opening region is smaller than that in the high-output mode so that a high priority is placed on the controllability of the motorcycle 1.

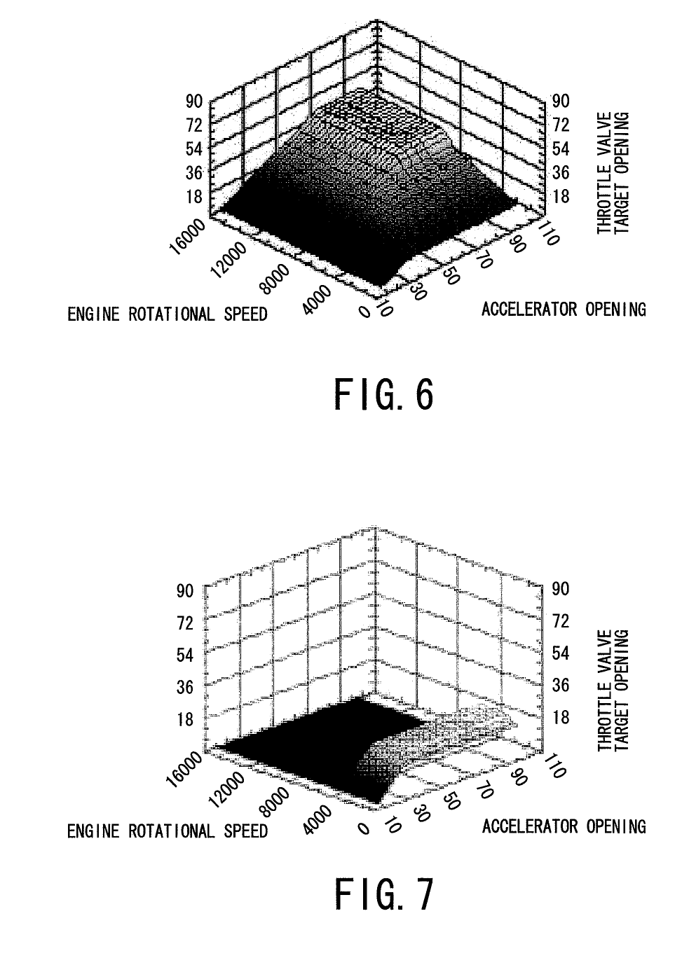

FIG. 6 shows the throttle valve opening map corresponding to the low-output mode. This throttle valve opening map is set in such a way that the target opening of the throttle valve 62 in a high accelerator opening region is limited to low values to prevent the motorcycle 1 from being abruptly accelerated and hence improve fuel consumption.

FIG. 7 shows the throttle valve opening map corresponding to a driving mode in which the maximum speed of the motorcycle 1 is limited in accordance with a legal speed on a public road. This throttle valve opening map is set in such a way that the target opening of the throttle valve 62 is limited to low values over substantially all the accelerator opening region so as to prevent in advance the speed of the motorcycle 1 from exceeding the legal speed.

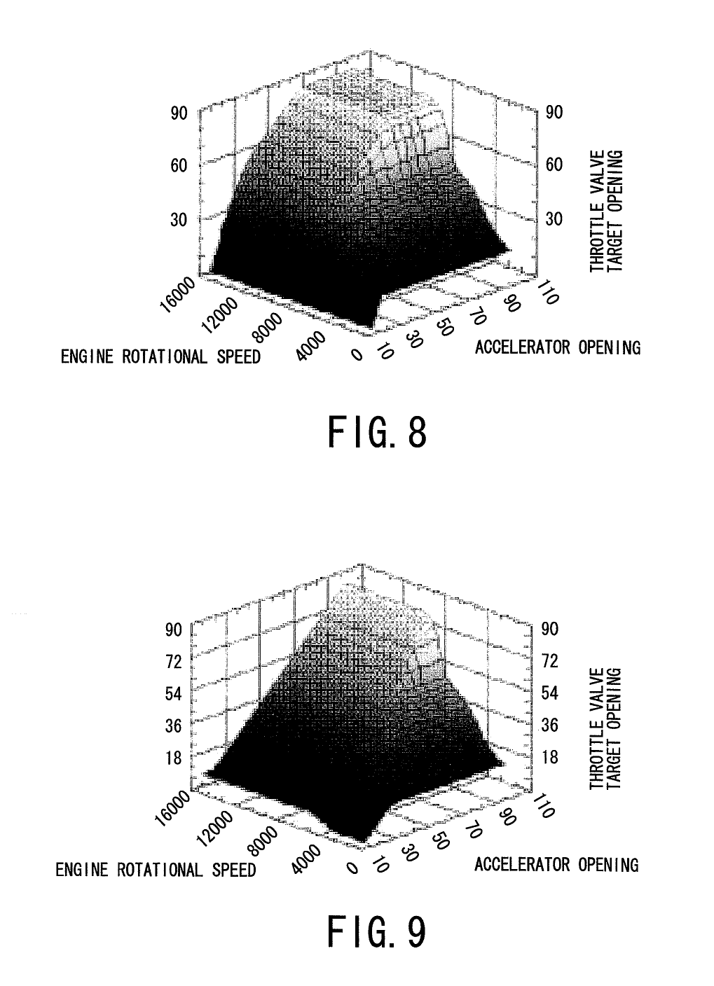

FIG. 8 shows the throttle valve opening map corresponding to a driving mode in which the target opening of the throttle valve 62 is abruptly increased in a low accelerator throttle opening region. This throttle valve opening map is set in such a way that a slight rotary operation of the accelerator grip 9 allows the opening of the throttle valve 62 to greatly increase and hence the motorcycle 1 to cruise at a high speed. In this way, an excessive urging force from a return spring (not shown) provided in the accelerator grip 9 otherwise applied to the rider to maintain a large amount of rotary operation of the accelerator grip 9 can be eliminated, whereby the fatigue of the rider can be reduced.

FIG. 9 shows the throttle valve opening map corresponding to a driving mode in which the target opening of the throttle valve 62 calculated when the accelerator opening is fully closed at a high engine rotational speed is set at a value slightly higher than the target opening of the throttle valve 62 calculated when the accelerator opening is fully closed at a low engine rotational speed (for example, the target opening of the throttle valve 62 is approximately 5 degrees when the accelerator grip 9 is operated to a fully-closed position at a low engine rotational speed, whereas the target opening of the throttle valve 62 is approximately 10 degrees when the accelerator grip 9 is operated to the fully-closed position at a high engine rotational speed). This throttle valve opening map allows engine braking to decrease in magnitude when the accelerator opening is fully closed in a high engine rotational speed range and hence the attitude of the motorcycle 1 to be readily maintained, for example, at the time of cornering.

In general, when the output from the engine is reduced in a dual throttle system, the amount of intake air is reduced by the amount corresponding to the reduction in engine output. In this case, to achieve an adequate air-fuel ratio, it is necessary to set the fuel injection quantity map and the ignition timing map in consideration of both the opening of the main throttle valve and the amount of intake air that decreases as the engine output decreases. In contrast, the electric throttle control apparatus 23 according to the present embodiment includes only the throttle valve 62 in the throttle body 20, and can hence uniquely determine the fuel injection quantity characteristics and the ignition timing characteristics in accordance with the throttle opening of the throttle valve 62. As a result, in the electric throttle control apparatus 23, an arbitrary point on the fuel injection quantity map always corresponds to a unique point on the ignition timing map based on the throttle opening of the throttle valve 62 detected by the throttle position sensor 68 and the engine rotational speed of the engine 19.

Therefore, in the electric throttle control apparatus 23, no special correction is required in setting the fuel injection quantity map and the ignition timing map, but only one fuel injection quantity map and ignition timing map may be set for a plurality of throttle valve opening maps, whereby the setting of the fuel injection quantity characteristics and the ignition timing characteristics can be significantly simplified.

The operation of the electric throttle control apparatus for the motorcycle according to the present embodiment of the present invention will now be described.

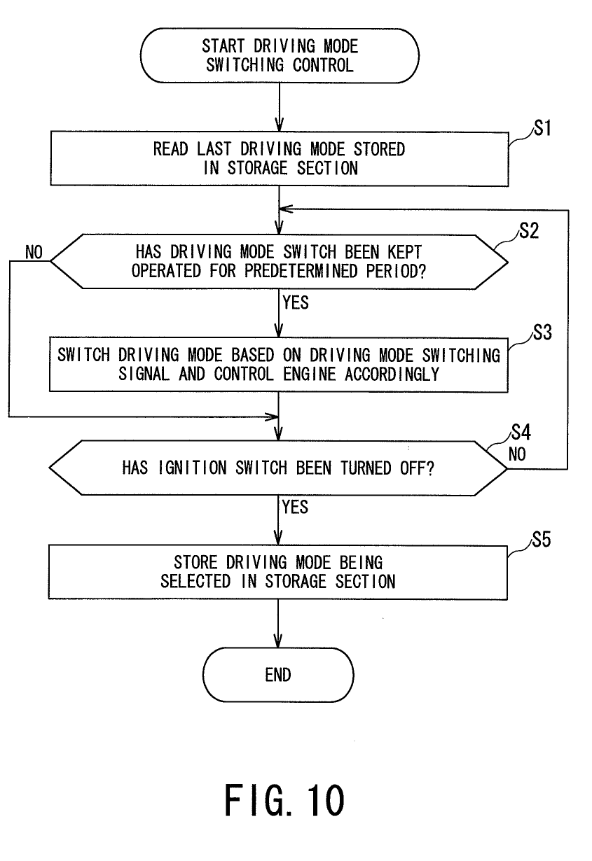

FIG. 10 is a flowchart showing driving mode switching control performed by the electric throttle control apparatus for the motorcycle according to the embodiment of the present invention.

As shown in FIG. 10, the electric control unit 73 in the electric throttle control apparatus 23 initiates driving mode switching control when the ignition switch 10 of the motorcycle 1 is turned ON.

First, in the step S1, the electric control unit 73 reads the driving mode stored in the storage section 79 when the ignition switch 10 of the motorcycle 1 traveled last time.

Next, in the step S2, the electric control unit 73 monitors whether or not the driving mode switch 71 has been kept operated for a predetermined period, for example, for 1 to 2 seconds. When the driving mode switch 71 has been kept operated for the predetermined period or longer, the control proceeds to the step S3, otherwise the control proceeds to the step S4.

In the step S3, the electric control unit 73 switches the driving mode based on the driving mode switching signal inputted from the driving mode switch 71 and controls the engine accordingly. Changing the driving mode means selecting one of the plurality of throttle valve opening maps. In this way, the electric control unit 73 not only controls the opening of the throttle valve 62 in accordance with the throttle valve opening map corresponding to a certain driving mode but also controls the fuel injection quantity and the ignition timing in accordance with the fuel injection quantity map and the ignition timing map.

In this process, when the rider operates the forward switch 71a of the driving mode switch 71, the electric control unit 73 switches the driving mode as follows: low-output mode intermediate-output mode high-output mode low-output mode and so on. On the other hand, when the rider operates the backward switch 71b of the driving mode switch 71, the electric control unit 73 switches the driving mode as follows: low-output mode→high-output mode→intermediate-output mode→low-output mode→and so on.

In the step S4, the electric control unit 73 judges whether or not the ignition switch 10 has been turned OFF. When the ignition switch 10 has been turned OFF, the control proceeds to the step S5, otherwise the control returns to the step S2 and the processes described above are repeated.

In the step S5, the electric control unit 73 stores the driving mode being selected in the storage section 79 and terminates the processes.

The thus configured electric throttle control apparatus 23 has the following features: Since a plurality of throttle valve opening characteristics are prepared in correspondence with the types of driving mode, the fuel injection quantity and the ignition timing can be determined based on the opening of the throttle valve 62 and the engine rotational speed. It is not necessary to correct the fuel injection quantity characteristics and the ignition timing characteristics whenever the driving mode is switched. It is also not necessary to prepare in advance a plurality of fuel injection quantity characteristics or ignition timing characteristics in correspondence with the types of driving mode.

As described above, the electric throttle control apparatus 23 according to the present embodiment can greatly reduce the consumed amount of memory of the storage section 79, shorten the length of time for control operations, and perform more precise control.

Further, unlike a dual throttle system, the electric throttle control apparatus 23 according to the present embodiment includes only the throttle valve 62, which is the electronic throttle valve, in the throttle body 20, whereby the length of the intake passage can be reduced and hence the intake response characteristics can be improved.

Therefore, the electric throttle control apparatus 23 according to the present embodiment has a plurality of driving modes in the electronic throttle valve system and can select desired one of the driving modes and switch the driving mode thereto.

What is claimed is:

1. An electric throttle control apparatus for a motorcycle comprising:
an accelerator position sensor for detecting an amount of operation of an accelerator grip;
an engine speed sensor for detecting an engine rotational speed;
an electric motor for rotating a throttle valve so as to be opened and closed an intake passage; and
a control unit for driving the electric motor depending upon an output value of the accelerator position sensor and the engine speed sensor,
wherein the control unit includes a map storage section storing a plurality of throttle valve opening maps, each of the plurality of throttle valve opening maps contains unique throttle valve opening characteristics respectively, and the control unit drives the electric motor based on one of selected the throttle valve opening maps.

2. The electric throttle control apparatus for the motorcycle according to claim 1,
wherein the control unit determines fuel injection quantity based on an opening of the throttle valve and the engine rotational speed.

3. The electric throttle control apparatus for the motorcycle according to claim 1,
wherein the control unit determines ignition timing based on an opening of the throttle valve and the engine rotational speed.

4. The electric throttle control apparatus for the motorcycle according to claim 1,
wherein the throttle valve opening maps are formed of at least three throttle valve opening maps containing the throttle valve opening characteristics different from one another.

5. The electric throttle control apparatus for the motorcycle according to claim 4,
wherein one of the throttle valve opening maps contains reference characteristics,
another one of the throttle valve opening maps contains high-output characteristics in which an opening of the throttle valve used when the amount of operation of the accelerator grip is small is set to be larger than that in the reference characteristics, and
another one of the throttle valve opening maps contains low-output characteristics in which a maximum opening of the throttle valve is limited to be lower than or equal to a predetermined opening that is lower than a maximum opening in the reference characteristics.

6. The electric throttle control apparatus for the motorcycle according to claims 1,
further comprising a map selector disposed in the vicinity of the accelerator grip, the map selector instructing the control unit to select one of the throttle valve opening maps from the map storage section.
